(19) United States
(12) Patent Application Publication
(10) Pub. No.: US 2009/0182926 A1
(43) Pub. Date: Jul. 16, 2009

(54) ELECTRONIC APPARATUS AND INFORMATION TRANSFER METHOD

(75) Inventor: Masaya TAKANO, Tokyo (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY CORPORATION, Tokyo (JP)

(21) Appl. No.: 12/336,247

(22) Filed: Dec. 16, 2008

(30) Foreign Application Priority Data
Jan. 15, 2008 (JP) 2008-005574

(51) Int. Cl. G06F 13/00

(52) U.S. Cl. 710/316

(57) ABSTRACT

Disclosed herein is an electronic apparatus including: an electrical contact configured to establish an electrical connection with another electronic apparatus to input or output information from or to the other electronic apparatus; a noncontact element configured to input or output information from or to the other electronic apparatus in a noncontact manner; and a signal processing section configured to exercise control over transfer of the information between the electronic apparatus and the other electronic apparatus, while selectively using the electrical contact and the noncontact element.

### CROSS REFERENCES TO RELATED APPLICATIONS

The present invention contains subject matter related to Japanese Patent Application JP 2008-005574, filed in the Japan Patent Office on Jan. 15, 2008, the entire contents of which being incorporated herein by reference.

### BACKGROUND OF THE INVENTION

1. Field of the Invention

The present invention relates to an electronic apparatus having a function of transferring information, and an information transfer method.

2. Description of the Related Art

With recent technological development, the amount of data handled on computers has been steadily increasing. This is not only true with the computers but also with televisions and so on that handle video signals, as a result of increasingly improved image quality.

For example, in “USB (Universal Serial Bus) 2.0,” which is a standard for transferring data between computers and their peripherals, 480 megabits of data must be handled per second. In “high-definition multimedia interface (HDMI),” which is a standard for transferring video between devices, approximately 4.5 gigabits of data must be handled per second, depending on image resolution.

As means for connecting such devices with each other, connectors or a combination of connectors and cables have been commonly used. However, the increasing rate of signal transfer has caused a need to pay attention to even the structure and precision of the connectors and the structure and manner of twisting of the cables connected to the connectors, as disclosed in Japanese Patent Laid-Open No. 2005-5272, for example, in order to maintain necessary properties.

As a solution to the above problem, there is a method of inputting and outputting data using noncontact elements such as inductive coupling elements or by radio. For example, Japanese Patent No. 3803364 describes a technique for inputting and outputting the data while supplying power to contactless radio frequency identification (RFID) with the use of a combination of an antenna, a detector diode, and a capacitor.

### SUMMARY OF THE INVENTION

The input and output of the data using the noncontact elements require complicated signal processing such as error correction and equalization, in order to reduce influence of surrounding noise, radio waves emitted from other devices, multipath, and so on. Power that is transferred using the noncontact elements is sufficient for the signal processing in the case where the amount of data processed per unit time is not too great. However, an increase in the amount of data processed per unit time involves an increase in required power, and may result in the power transferred using the noncontact elements being insufficient.

Moreover, in the case of the input and output of the data using the noncontact elements, it is necessary, when transferring the data, to superimpose control signals necessary for the error correction and synchronization between the devices or the like upon the data, resulting in increased complexity in data generation and data decoding. Furthermore, if an error occurs that cannot be corrected by the error correction for the data, the control signals superimposed upon the data also cannot be obtained, which may result in an inability to transfer the data.

The present invention addresses the above-identified, and other problems associated with conventional methods and apparatuses, and provides an electronic apparatus and an information transfer method that allow information transfer while making the most use of advantages of both a high-speed transmission path and a secure and reliable transmission path.

According to one embodiment of the present invention, there is provided an electronic apparatus including: an electrical contact configured to establish an electrical connection with another electronic apparatus to input or output information from or to the other electronic apparatus; a noncontact element configured to input or output information from or to the other electronic apparatus in a noncontact manner; and a signal processing section configured to exercise control over transfer of the information between the electronic apparatus and the other electronic apparatus, while selectively using the electrical contact and the noncontact element.

According to this electronic apparatus, it is possible to accomplish information transfer while making the most use of advantages of both a high-speed transmission path and a secure and reliable transmission path.

According to another embodiment of the present invention, there is provided an information transfer method for transferring information between a plurality of electronic apparatuses, each of the electronic apparatuses having an electrical contact configured to establish an electrical connection with another one of the electronic apparatuses to input or output information from or to the other electronic apparatus, and a noncontact element configured to input or output information from or to the other electronic apparatus in a noncontact manner, wherein the information is transferred between the electronic apparatuses, with selective use of the electrical contacts and the noncontact elements.

According to the above electronic apparatus and information transfer method, it is possible to accomplish information transfer while making the most use of advantages of both a high-speed transmission path and a secure and reliable transmission path.

### BRIEF DESCRIPTION OF THE DRAWINGS

FIG. 1 is a block diagram illustrating an information transfer system for electronic apparatuses according to one embodiment of the present invention;

FIG. 2 is a block diagram illustrating the structure of a signal processing section as shown in FIG. 1;

FIG. 3 is a sequence diagram in the case where data is transferred between the electronic apparatuses using noncontact elements;

FIG. 4 is a sequence diagram in the case where the data is transferred between the electronic apparatuses using data pins;

FIG. 5 is a flowchart illustrating a procedure, performed in the electronic apparatus at the transmitting end, from a preparation for data transmission until the data transmission;

FIG. 6 is a flowchart illustrating a procedure, performed in the electronic apparatus at the receiving end, from a preparation for data reception until the data reception;

FIG. 7 illustrates a first specific example of the information transfer system for the electronic apparatuses according to one embodiment of the present invention;

FIG. 8 illustrates a second specific example of the information transfer system for the electronic apparatuses according to one embodiment of the present invention; and

FIG. 9 illustrates a third specific example of the information transfer system for the electronic apparatuses according to one embodiment of the present invention.

### DETAILED DESCRIPTION OF THE PREFERRED EMBODIMENTS

Hereinafter, preferred embodiments of the present invention will be described with reference to the accompanying drawings.

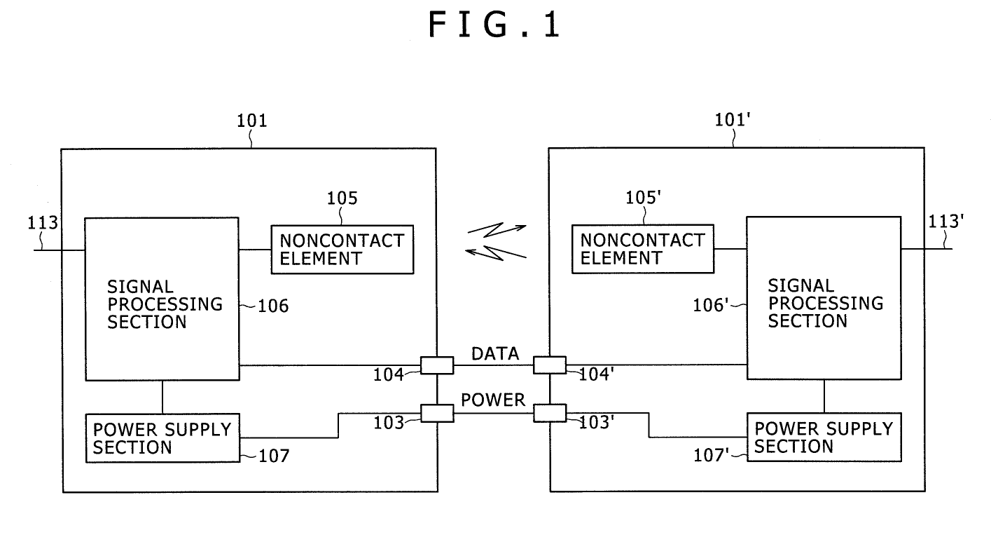

FIG. 1 is a block diagram illustrating electronic apparatuses and an information transfer system therefor according to one embodiment of the present invention.

An electronic apparatus 101 includes a signal processing section 106, a power supply section 107, a data pin 104, a power pin 103, and a noncontact element 105. An electronic apparatus 101′ includes a signal processing section 106′, a power supply section 107′, a data pin 104′, a power pin 103′, and a noncontact element 105′.

The signal processing sections 106 and 106′ may have different structures depending on specific configurations of the electronic apparatuses 101 and 101′. For example, the signal processing sections 106 and 106′ perform a process of exchanging data with an external device (which is not an electronic apparatus according to an embodiment of the present invention) via data input/output lines 113 and 113′, respectively, and perform various types of signal processing and control for transferring the data between the electronic apparatuses 101 and 101′ while selectively using the data pins 104 and 104′ and the noncontact elements 105 and 105′. More specifically, each of the signal processing sections 106 and 106′ may be a microcomputer including a central processing unit (CPU), a random-access memory (RAM), and a read-only memory (ROM), or a logic circuit designed for a specific use.

The power supply sections 107 and 107′ are modules for supplying power for operation to each module in the electronic apparatuses 101 and 101′, respectively.

The data pins 104 and 104′ are electrical contacts used to transfer information, such as the data, between the electronic apparatuses 101 and 101′. The form, e.g., the number of pins and the shape, of the data pins 104 and 104′ may vary depending on the electronic apparatuses 101 and 101′.

The power pins 103 and 103′ are electrical contacts used to transfer power for operation between the electronic apparatuses 101 and 101′. For example, the power for operation may be supplied from the electronic apparatus 101 to the electronic apparatus 101′ via the power pins 103 and 103′. Conversely, the power may be supplied from the electronic apparatus 101′ to the electronic apparatus 101.

The noncontact elements 105 and 105′ are used to transfer the information, such as the data, between the electronic apparatuses 101 and 101′ in a noncontact manner. The noncontact elements 105 and 105′ are elements used for performing noncontact communication, such as electromagnetic coupling-type elements using mutual induction, electromagnetic induction-type elements using electromagnetic induction, electrostatic induction-type elements using electrostatic induction, or optical-type elements.

In a system of data transfer between the electronic apparatuses according to this embodiment, the data pins 104 and 104′ or the noncontact elements 105 and 105′ are selectively used to perform the data transfer between the electronic apparatuses 101 and 101′.

Note that each of the electronic apparatuses 101 and 101′ has the aforementioned sections, but that the sections in the electronic apparatus 101 may not necessarily be identical to those in the electronic apparatus 101′. The data pins 104 and 104′ of the electronic apparatuses 101 and 101′ may be connected to each other either directly or via a cable. Also, the power pins 103 and 103′ of the electronic apparatuses 101 and 101′ may be connected to each other either directly or via a cable.

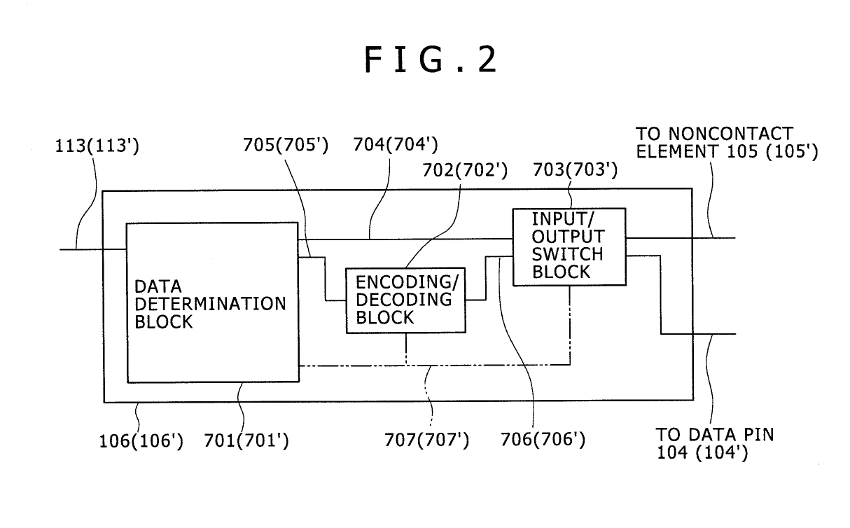

FIG. 2 is a block diagram illustrating the structure of the signal processing section 106 (106′). Reference characters outside parentheses are reference characters for the blocks in the signal processing section 106 of the electronic apparatus 101, whereas reference characters inside the parentheses are reference characters for the blocks in the signal processing section 106′ of the electronic apparatus 101′. As shown in FIG. 2, the signal processing section 106 (106′) includes a data determination block 701 (701′), an encoding/decoding block 702 (702′), an input/output switch block 703 (703′), data lines 704 (704′), 705 (705′), and 706 (706′), and a control line 707 (707′). The data lines 704 (704′), 705 (705′), and 706 (706′) and the control line 707 (707′) connect the data determination block 701 (701′), the encoding/decoding block 702 (702′), and the input/output switch block 703 (703′) to one another.

Each module in the signal processing section 106 (106′) has a mode for operating as a module at a transmitting end and a mode for operating as a module at a receiving end. When one of the signal processing sections 106 and 106′ operates as a unit at the transmitting end, the other of the signal processing sections 106 and 106′ operates as a unit at the receiving end. It is assumed in the following description that the signal processing section 106 of the electronic apparatus 101 operates as a unit at the transmitting end, while the signal processing section 106′ of the electronic apparatus 101′ operates as a unit at the receiving end.

First, a function of the data determination block 701 in the signal processing section 106, which operates as a unit at the transmitting end, will now be described below.

The data determination block 701 determines the type of data that has been inputted thereto from an outside (e.g., a module or device that is not an electronic apparatus according to an embodiment of the present invention) and which is to be transmitted, based on an identifier of the data type described in a header of the data or the like, for example. Examples of the data type include document, image, video, audio, computer program, and stream data. Based on the data type determined, the data determination block 701 determines whether the data is data that should be transferred at a high speed. The data that should be transferred at a high speed is data that involves a speed constraint, such as data that is to be played back in real time at the receiving end. Specific examples of the data that should be transferred at a high speed include video, audio, or other stream data. When determining whether the data is data that should be transferred at a high speed, the data determination block 701 may take a total size of the data into account, instead of simply determining it based on the data type. Also, the data determination block 701 may determine whether the data is data that should be transferred at a high speed, based only on the total size of the data.

The data determination block 701 has a function of making a preparation for data transmission in a manner described below, based on the result of the above determination.

In the case where the data to be transmitted is data that should be transferred at a high speed, the data determination block 701 controls the input/output switch block 703 to use the noncontact element 105 when transmitting the data to the electronic apparatus 101′ at the receiving end, and instructs the encoding/decoding block 702 to add an error correcting code to the data in order to ensure reliability of the transfer, and to encrypt the data in order to ensure security in the transfer. Meanwhile, in the case where it has been determined that the data to be transmitted is data that does not have to be transferred at a high speed, the data determination block 701 controls the input/output switch block 703 to use the data pin 104 when transmitting the data to the electronic apparatus 101′ at the receiving end, and determines whether the data has a high degree of importance, and, if the data has a high degree of importance, instructs the encoding/decoding block 702 to encrypt the data.

There are several methods that can be employed by the data determination block 701 to determine the degree of importance of the data. For example, the data determination block 701 may determine the degree of importance of the data based on the type of the data. Also, the data transmitted from the external device may have information added thereto about the degree of importance of the data. In this case, the data determination block 701 may determine the degree of importance of the data based on that information.

In addition, based on the preparation for the data transmission, the data determination block 701 generates a notification that includes information necessary for the electronic apparatus 101′ at the receiving end to make a preparation for data reception, and transmits this notification to the electronic apparatus 101′ at the receiving end via a transmission path of the data pin 104. Here, this notification includes: information that specifies whether the electronic apparatus 101′ at the receiving end should use the data pin 104′ or the noncontact element 105′ when receiving the data from the electronic apparatus 101; information that indicates whether the data is encrypted or not; information that indicates whether the error correcting code has been added to the data; a secret key used when encrypting the data (in the case where the data is encrypted); and so on.

The electronic apparatuses 101 and 101′ are configured, in their initial state, to use the data pins 104 and 104′ when exchanging other information than the data, e.g., the notification, between the electronic apparatuses 101 and 101′.

Next, the data determination block 701′ in the signal processing section 106′, which operates as a unit at the receiving end, will now be described below.

The data determination block 701′ in the signal processing section 106′ at the receiving end has a function of making the preparation for the data reception in a manner described below, based on the information included in the notification acquired from the electronic apparatus 101 at the transmitting end.

Based on the information included in the acquired notification, the data determination block 701′ instructs the input/output switch block 703′ to use the specified transmission path, i.e., the noncontact element 105′ or the data pin 104′, when receiving the data from the electronic apparatus 101. In addition, in the case where the data determination block 701′ has determined that use of the noncontact element 105′ is specified, the data determination block 701′ instructs the encoding/decoding block 702′ to decrypt the data and perform error correction on the data, and passes the secret key included in the acquired notification to the encoding/decoding block 702′.

Meanwhile, in the case where the data determination block 701′ has determined that use of the data pin 104′ is specified when receiving the data from the electronic apparatus 101, the data determination block 701′ instructs the encoding/decoding block 702′ whether or not to decrypt the data, based on the information included in the acquired notification, and if the data is to be decrypted, the data determination block 701′ passes the secret key included in the acquired notification to the encoding/decoding block 702′.

The encoding/decoding block 702 (702′) operates as an encoding block when used at the transmitting end, and as a decoding block when used at the receiving end. In accordance with the instruction from the data determination block 701, the encoding/decoding block 702 in the signal processing section 106 at the transmitting end adds the error correcting code to the data to be transmitted and encrypts the data. In accordance with the instruction from the data determination block 701′, the encoding/decoding block 702′ in the signal processing section 106′ at the receiving end decrypts the data and performs the error correction on the data.

In accordance with the instruction from the data determination block 701 (701′), the input/output switch block 703 (703′) switches the transmission path for the data transfer between the electronic apparatuses 101 and 101′, between the noncontact element 105 (105′) and the data pin 104 (104′).

Next, operations of the electronic apparatuses 101 and 101′ according to this embodiment of the present invention will now be described below.

It is assumed in the following description that the electronic apparatus 101 is the transmitter of the data, whereas the electronic apparatus 101′ is the receiver of the data. Here, as noted previously, the data to be transmitted and received refers to the document, the image, the video, the audio, the computer program, the stream data, or the like, and does not refer to the notification that is exchanged between the electronic apparatuses 101 and 101′, before or after the data transfer therebetween, for the control of the data transfer.

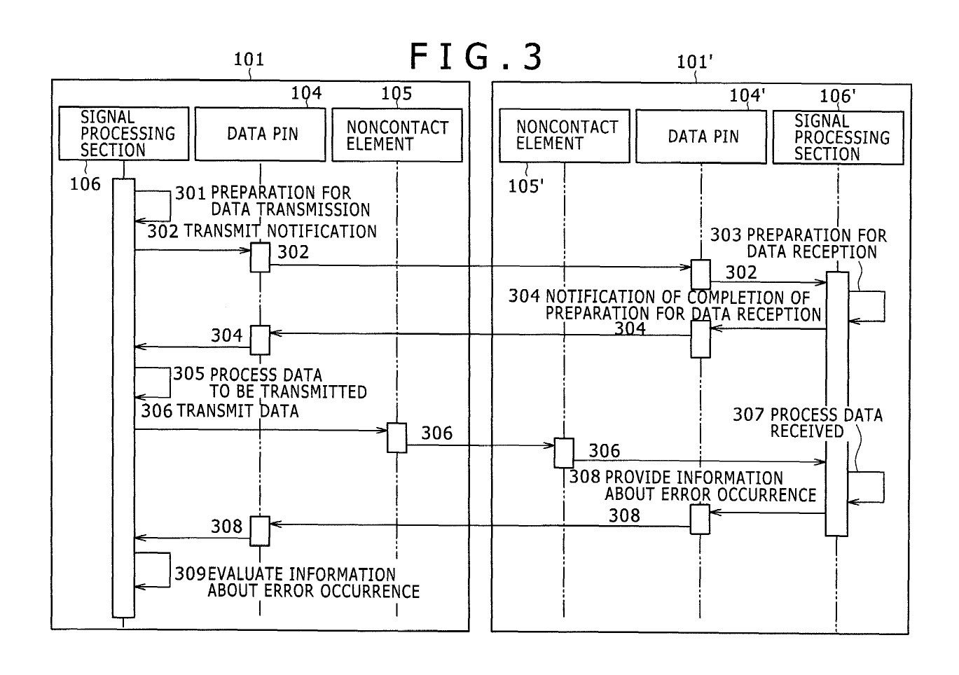

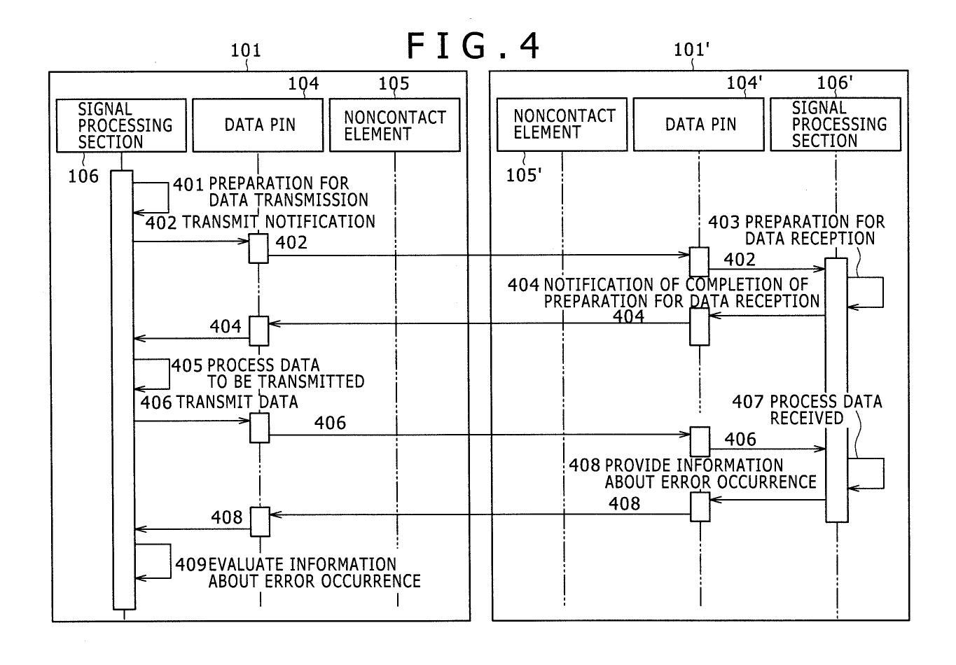

FIG. 3 is a sequence diagram in the case where the data is transferred between the electronic apparatuses 101 and 101′ using the noncontact elements 105 and 105′. FIG. 4 is a sequence diagram in the case where the data is transferred between the electronic apparatuses 101 and 101′ using the data pins 104 and 104′.

### Preparation for Data Transmission

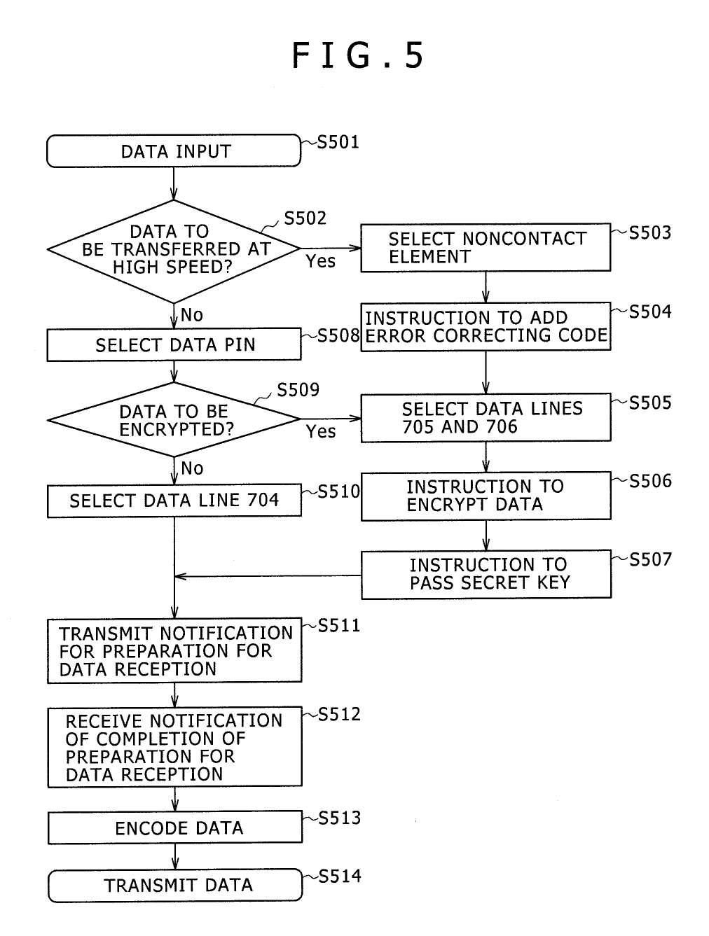

First, the operation of the preparation for the data transmission (FIG. 3: 301) in the signal processing section 106 in the electronic apparatus 101 at the transmitting end will now be described below. FIG. 5 is a flowchart illustrating a procedure, performed in the electronic apparatus 101 at the transmitting end, from the preparation for the data transmission (FIG. 3: 301, FIG. 4: 401) until the data transmission (FIG. 3: 306, FIG. 4: 406).

The signal processing section 106 in the electronic apparatus 101 at the transmitting end receives, from the outside (e.g., the module or device that is not an electronic apparatus according to an embodiment of the present invention) via the data input/output line 113, the data to be transmitted (FIG. 5: step S501), and the data determination block 701 determines whether the inputted data is data that should be transferred at a high speed, based on the type of the data, the total size of the data, or the like (FIG. 5: step S502).

In the case where the data determination block 701 has determined that the inputted data is data that should be transferred at a high speed, the data determination block 701 instructs, via the control line 707, the input/output switch block 703 to use the transmission path of the noncontact element 105 when transmitting the data to the electronic apparatus 101′ at the receiving end, as illustrated in FIG. 3 (FIG. 5: step S503). In addition, the data determination block 701 instructs, via the control line 707, the encoding/decoding block 702 to add the error correcting code to the data to be transmitted (FIG. 5: step S504). Generally speaking, in wireless data communication, such as that which uses the noncontact elements, transmission characteristics are easily affected by a noise environment. As such, the reliability of the data transfer can be increased by adding the error correcting code to the data at the transmitting end and performing the error correction on the data at the receiving end, as described above.

Next, the data determination block 701 configures itself to output the data to the encoding/decoding block 702 via the data line 705, and instructs, via the control line 707, the encoding/decoding block 702 to transmit the data from the encoding/decoding block 702 to the input/output switch block 703 via the data line 706 (FIG. 5: step S505). In the above-described manner, the data determination block 701 performs settings so that the data to be transmitted will be outputted to the input/output switch block 703 through the encoding/decoding block 702.

Next, the data determination block 701 instructs, via the control line 707, the encoding/decoding block 702 to encrypt the data to which the error correcting code has been added (FIG. 5: step S506). Further, the data determination block 701 instructs, via the control line 707, the encoding/decoding block 702 to pass the secret key used when encrypting the data to the data determination block 701, thereby acquiring the secret key from the encoding/decoding block 702 (FIG. 5: step S507). The preparation for the data transmission (FIG. 3: 301) in the electronic apparatus 101 at the transmitting end is complete at this stage, in the case where the inputted data is data that should be transferred at a high speed.

Thereafter, based on the above-described preparation for the data transmission, the data determination block 701 generates the notification that includes the information that is necessary for the electronic apparatus 101′ at the receiving end to make the preparation for the data reception, passes the notification to the input/output switch block 703 via the data line 704, and instructs, via the control line 707, the input/output switch block 703 to transmit the notification to the electronic apparatus 101′ at the receiving end via the transmission path of the data pin 104. In accordance with this instruction, the input/output switch block 703 transmits the notification passed from the data determination block 701 to the electronic apparatus 101′ at the receiving end via the transmission path of the data pin 104 (FIG. 3: 302, FIG. 5: step S511). This notification includes: information that specifies that the electronic apparatus 101′ at the receiving end should use the transmission path of the noncontact element 105′ for the data transfer; information that indicates that the data is encrypted; information that indicates that the error correcting code is added to the data; and the secret key used when encrypting the data.

Meanwhile, in the case where the data determination block 701 has determined at step S502 that the inputted data is data that does not have to be transferred at a high speed, the data determination block 701 instructs, via the control line 707, the input/output switch block 703 to use the transmission path of the data pin 104 to transmit the data to the electronic apparatus 101′ at the receiving end, as illustrated in FIG. 4 (FIG. 5: step S508).

Next, based on the degree of importance of the data to be transmitted, the data determination block 701 determines whether this data is data that should be encrypted (FIG. 5: step S509). In the case where this data is data that should be encrypted, the data determination block 701 configures itself to output the data to the encoding/decoding block 702 via the data line 705, and instructs, via the control line 707, the encoding/decoding block 702 to transmit the data from the encoding/decoding block 702 to the input/output switch block 703 via the data line 706 (FIG. 5: step S505).

Next, the data determination block 701 instructs, via the control line 707, the encoding/decoding block 702 to encrypt the data (FIG. 5: step S506), and instructs, via the control line 707, the encoding/decoding block 702 to pass the secret key used when encrypting the data to the data determination block 701, thereby acquiring the secret key from the encoding/decoding block 702 (FIG. 5: step S507). The preparation for the data transmission (FIG. 4: 401) in the electronic apparatus 101 at the transmitting end is complete at this stage, in the case where data that does not have to be transferred at a high speed but should be encrypted is to be transferred.

Thereafter, based on the above-described preparation for the data transmission, the data determination block 701 generates the notification that includes the information that is necessary for the electronic apparatus 101′ at the receiving end to make the preparation for the data reception, passes the notification to the input/output switch block 703 via the data line 704, and instructs, via the control line 707, the input/output switch block 703 to transmit the notification to the electronic apparatus 101′ at the receiving end via the transmission path of the data pin 104. In accordance with this instruction, the input/output switch block 703 transmits the notification passed from the data determination block 701 to the electronic apparatus 101′ at the receiving end via the transmission path of the data pin 104 (FIG. 4: 402, FIG. 5: step S511). This notification includes: information that specifies that the electronic apparatus 101′ at the receiving end should use the data pin 104′ for the data transfer; the information that indicates that the data is encrypted; information that indicates that the error correcting code is not added to the data; and the secret key used when encrypting the data.

Meanwhile, in the case where it is determined at step S509 that the data to be transmitted does not have to be encrypted, the data determination block 701 configures itself to output the data to the input/output switch block 703 via the data line 704 (FIG. 5: step S510). The preparation for the data transmission (FIG. 4: 401) in the electronic apparatus 101 at the transmitting end is complete at this stage, in the case where data that does not have to be transferred at a high speed or encrypted is to be transferred.

Next, based on the above-described preparation for the data transmission, the data determination block 701 generates the notification that includes the information that is necessary for the electronic apparatus 101′ at the receiving end to make the preparation for the data reception, passes the notification to the input/output switch block 703 via the data line 704, and instructs, via the control line 707, the input/output switch block 703 to transmit the notification to the electronic apparatus 101′ at the receiving end via the transmission path of the data pin 104. In accordance with this instruction, the input/output switch block 703 transmits the notification passed from the data determination block 701 to the electronic apparatus 101′ at the receiving end via the transmission path of the data pin 104 (FIG. 4: 402, FIG. 5: step S511). This notification includes: information that specifies the use of the data pin for the data transfer; information that indicates that the data is not encrypted; and the information that indicates that the error correcting code is not added to the data.

### Preparation for Data Reception

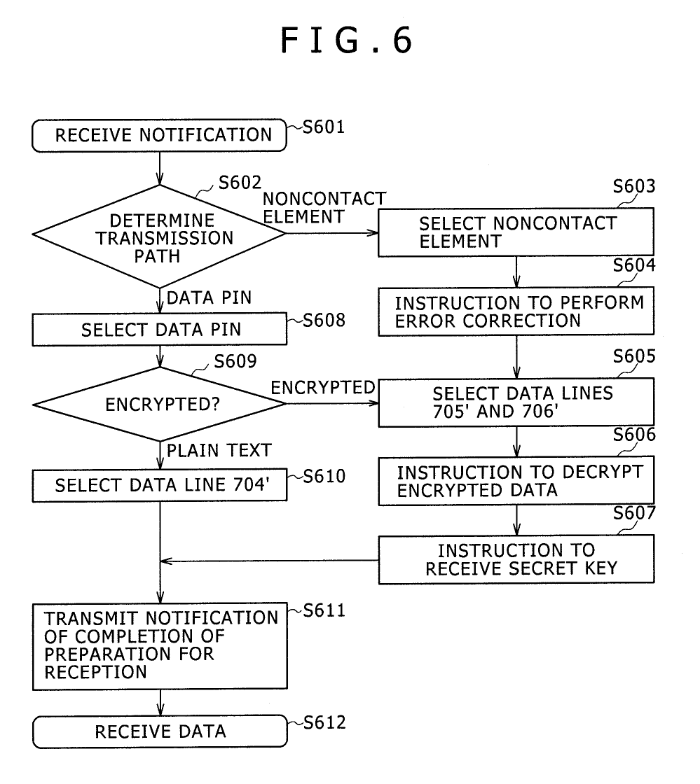

Next, an operation of the preparation for the data reception (FIG. 3: 303, FIG. 4: 403) in the signal processing section 106′ in the electronic apparatus 101′ at the receiving end will now be described below. FIG. 6 is a flowchart illustrating a procedure, performed in the electronic apparatus 101′ at the receiving end, from the preparation for the data reception (FIG. 3: 303, FIG. 4: 403) until the data reception (FIG. 3: 307, FIG. 4: 407).

In the signal processing section 106′ in the electronic apparatus 101′ at the receiving end, the input/output switch block 703′ is configured, in its initial state, to use the transmission path of the data pin 104′ to exchange the information with the electronic apparatus 101 at the transmitting end. Accordingly, the notification from the electronic apparatus 101 at the transmitting end is passed to the signal processing section 106′ in the electronic apparatus 101′ at the receiving end via the data pins 104 and 104′ (FIG. 6: step S601). In addition, in the initial state, the input/output switch block 703′ is configured to pass the inputted information to the data determination block 701′ via the data line 704′. Accordingly, the notification from the electronic apparatus 101 at the transmitting end is passed from the input/output switch block 703′ to the data determination block 701′ via the data line 704′.

Based on the information included in the acquired notification, the data determination block 701′ determines which of the transmission path of the noncontact element 105′ and the transmission path of the data pin 104′ is to be used to receive the data from the electronic apparatus 101 at the transmitting end (FIG. 6: step S602). If the data determination block 701′ determines that the use of the noncontact element 105′ is specified, the data determination block 701′ instructs, via the control line 707′, the input/output switch block 703′ to use the noncontact element 105′ (FIG. 6: step S603). In addition, the data determination block 701′ considers that the data that is to be transmitted from the electronic apparatus 101 is encrypted and has the error-correcting code added thereto, and instructs, via the control line 707′, the encoding/decoding block 702′ to perform the error correction on the data (FIG. 6: step S604).

Note that it has been assumed in this embodiment that, when the data determination block 701′ has determined that the use of the transmission path of the noncontact element 105′ by the electronic apparatus 101′ at the receiving end is specified for receiving the data from the electronic apparatus 101 at the transmitting end, the data determination block 701′ always determines that the data that is to be transmitted from the electronic apparatus 101 is encrypted and has the error-correcting code added thereto. Note, however, that the data determination block 701′ may determine whether the data is encrypted or not and whether the error correcting code has been added to the data, based on information concerning the decoding included in the acquired notification, i.e., the information indicating whether the data is encrypted or not and the information indicating whether the error correcting code has been added to the data.

Further, the data determination block 701′ instructs, via the control line 707′, the input/output switch block 703′ to pass the data to the encoding/decoding block 702′ via the data line 706′, and configures itself to receive an output from the encoding/decoding block 702′ via the data line 705′ (FIG. 6: step S605).

Next, the data determination block 701′ instructs, via the control line 707′, the encoding/decoding block 702′ to decode the data (i.e., decrypt the encrypted data) (FIG. 6: step S606). Then, the data determination block 701′ instructs, via the control line 707′, the encoding/decoding block 702′ to receive the secret key (FIG. 6: step S607), and passes the secret key included in the notification to the encoding/decoding block 702′ via the data line 705′. The preparation for the data reception (FIG. 3: 303) in the electronic apparatus 101′ at the receiving end is complete at this stage, in the case where the electronic apparatus 101′ at the receiving end uses the transmission path of the noncontact element 105′ when receiving the data.

Thereafter, the data determination block 701′ transmits, to the electronic apparatus 101 at the transmitting end via the transmission path of the data pin 104′, a notification that indicates that the preparation for the data reception has been completed in the electronic apparatus 101′ at the receiving end (FIG. 3: 304, FIG. 6: step S611).

Meanwhile, if the data determination block 701′ determines at step S602 that the transmission path of the data pin 104′ should be used when receiving the data from the electronic apparatus 101 at the transmitting end, the data determination block 701′ instructs, via the control line 707′, the input/output switch block 703′ to use the transmission path of the data pin 104′ (FIG. 6: step S608).

Next, based on the information included in the acquired notification, the data determination block 701′ determines whether the data that is to be received is encrypted (FIG. 6: step S609). If the data determination block 701′ determines that the data that is to be received is encrypted, the data determination block 701′ instructs, via the control line 707′, the input/output switch block 703′ to pass the received data to the encoding/decoding block 702′ via the data line 706′, and configures itself to receive the output from the encoding/decoding block 702′ via the data line 705′ (FIG. 6: step S605).

Next, the data determination block 701′ instructs, via the control line 707′, the encoding/decoding block 702′ to decode the data (i.e., decrypt the encrypted data) (FIG. 6: step S606). Then, the data determination block 701′ instructs, via the control line 707′, the encoding/decoding block 702′ to receive the secret key needed to decrypt the encrypted data (FIG. 6: step S607), and passes the secret key included in the notification to the encoding/decoding block 702′ via the data line 705′. The preparation for the data reception (FIG. 4: 403) in the electronic apparatus 101′ at the receiving end is complete at this stage, in the case where the electronic apparatus 101′ at the receiving end uses the transmission path of the data pin 104′ when receiving the data and the data is encrypted.

Thereafter, the data determination block 701′ transmits, to the electronic apparatus 101 at the transmitting end via the transmission path of the data pin 104′, the notification that indicates that the preparation for the data reception has been completed in the electronic apparatus 101′ at the receiving end (FIG. 4: 404, FIG. 6: step S611).

Meanwhile, if it is determined at step S609 that the data that is to be received is in plain text, i.e., in unencrypted form, the data determination block 701′ instructs, via the control line 707′, the input/output switch block 703′ to pass the data via the data line 704′ (step S610). The preparation for the data reception (FIG. 4: 403) in the electronic apparatus 101′ at the receiving end is complete at this stage, in the case where the electronic apparatus 101′ at the receiving end uses the transmission path of the data pin 104′ when receiving the data and the data is not encrypted.

The preparation for the data reception (FIG. 3: 303, FIG. 4: 403) in the electronic apparatus 101′ at the receiving end has been described above.

Thereafter, the signal processing section 106′ in the electronic apparatus 101′ at the receiving end provides, to the electronic apparatus 101 at the transmitting end via the transmission path of the data pin 104′, the notification that the preparation for the data reception has been completed in the electronic apparatus 101′ at the receiving end (FIG. 3: 304, FIG. 4: 404, FIG. 6: step S611).

The signal processing section 106 in the electronic apparatus 101 at the transmitting end receives, from the electronic apparatus 101′ at the receiving end via the transmission path of the data pin 104, the notification of the completion of the preparation for the data reception (FIG. 5: step S512). Then, the signal processing section 106 controls the encoding/decoding block 702 to encode the data inputted from the outside via the data input/output line 113 (FIG. 3: 305, FIG. 4: 405, FIG. 5: step S513), in accordance with the instruction concerning the encoding as provided from the data determination block 701 in the preparation for the data transmission (FIG. 3: 301, FIG. 4: 401) (i.e., the instruction as to whether the data should be encrypted or not and the instruction as to whether the error correcting code should be added to the data). Then, the signal processing section 106 controls the encoded data to be transmitted to the electronic apparatus 101′ at the receiving end via the transmission path of the noncontact element 105 or the data pin 104 as specified in the preparation for the data transmission (FIG. 3: 306, FIG. 4: 406, FIG. 5: step S514).

On the other hand, the signal processing section 106′ in the electronic apparatus 101′ at the receiving end receives the data from the electronic apparatus 101 at the transmitting end via the transmission path or the noncontact element 105′ or the data pin 104′ as specified in the preparation for the data reception (FIG. 3: 303, FIG. 4: 403). Then, the signal processing section 106′ decodes the received data (FIG. 3: 307, FIG. 4: 407, FIG. 6: step S612) in accordance with the instruction concerning the decoding as provided from the data determination block 701′ in the preparation for the data reception (FIG. 3: 303, FIG. 4: 403) (i.e., the instruction as to whether the received data should be decrypted, and the instruction as to whether the error correction should be performed on the received data).

Upon completion of the decoding of the received data, the signal processing section 106′ in the electronic apparatus 101′ at the receiving end transmits, to the electronic apparatus 101 at the transmitting end via the transmission path of the data pin 104′, information about error occurrence, e.g., the number of blocks where an error has been detected in the error correction (FIG. 3: 308, FIG. 4: 408). Upon receipt of the information about the error occurrence from the electronic apparatus 101′ at the receiving end, the signal processing section 106 in the electronic apparatus 101 at the transmitting end evaluates the information about the error occurrence in accordance with a predetermined criterion, to determine whether retransmission of the data is necessary (FIG. 3: 309, FIG. 4: 409). If the signal processing section 106 determines that the retransmission of the data is necessary, the signal processing section 106 transmits the data via the same transmission path as in the previous transmission of the data.

As described above, according to this embodiment, the high-speed data does not pass through the data pins 104 and 104′ of the electronic apparatuses 101 and 101′. Thus, inexpensive data pins with a relatively simple structure may be used as the data pins 104 and 104′, and accordingly, an inexpensive substrate may be used as a substrate on which the data pins 104 and 104′ are installed.

In addition, according to this embodiment, it is possible to use the optimum transmission path for the data transfer, depending on characteristics of the data transferred or characteristics of the data transfer. For example, it is possible to transfer low-speed data, data that does not permit an error in transmission, highly confidential data, or the like via the transmission path of the data pins 104 and 104′, and to transfer the high-speed data that cannot be transferred via the inexpensive data pins with a relatively simple structure via the transmission path of the noncontact elements 105 and 105′. Furthermore, when transferring the data via the transmission path of the data pins 104 and 104′, complicated signal processing, such as the error correction or the equalization, is not necessary, leading to a reduction in load of the signal processing at the time of the data transfer.

Still further, according to this embodiment, the notifications that are necessary to start or complete the control for the data transfer can be exchanged between the electronic apparatuses 101 and 101′ securely via the transmission path of the data pins 104 and 104′ before or after the data transfer, in the case where the data is transferred via the transmission path of the noncontact elements 105 and 105′.

Still further, according to this embodiment, the power is supplied from one of the electronic apparatuses 101 and 101′ to the other one of the electronic apparatuses 101 and 101′ via the power pins 103 and 103′. Thus, supply of higher power is possible than when supplying the power from the electronic apparatus 101 to the electronic apparatus 101′ in a noncontact manner, so that sufficient power can be obtained for the signal processing required to transfer the data via the transmission path of the noncontact elements 105 and 105′.

Next, specific examples of the electronic apparatuses and information transfer systems therefor according to embodiments of the present invention will now be described below.

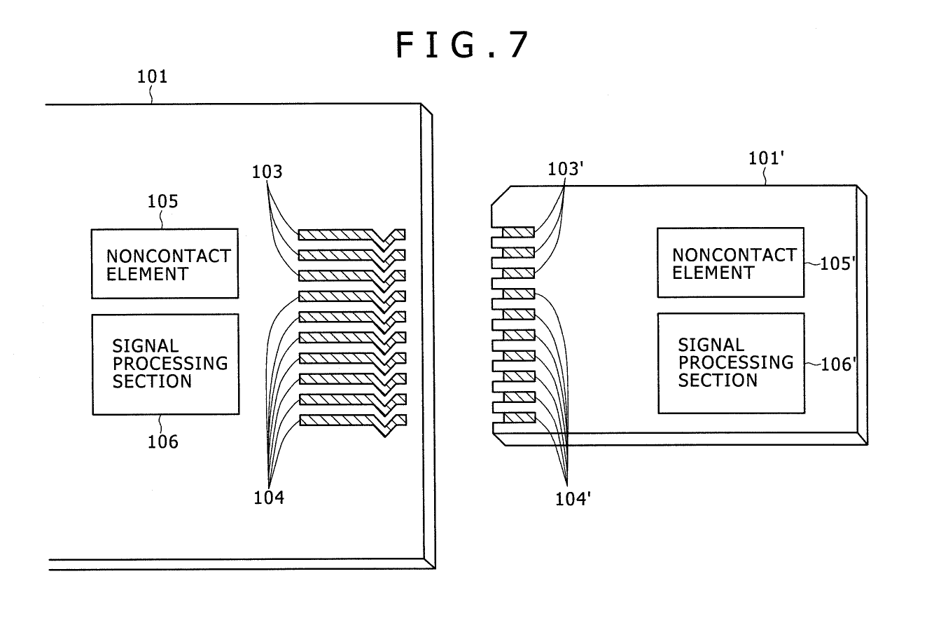

FIG. 7 illustrates a first specific example. In this example, the electronic apparatus 101 at the transmitting end is a card interface unit of a device such as a computer, while the electronic apparatus 101′ at the receiving end is a card-shaped electronic apparatus such as a memory card. The card interface unit 101 is provided with a plurality of power pins 103 and a plurality of data pins 104, while the card-shaped electronic apparatus 101′ is provided with a plurality of power pins 103′ and a plurality of data pins 104′ corresponding to the power pins 103 and the data pins 104, respectively, of the card interface unit 101. Each of the card interface unit 101 and the card-shaped electronic apparatus 101′ is provided with the noncontact element 105 or 105′, the signal processing section 106 or 106′, and the power supply section (not shown). As in the above-described embodiment, the data pins 104 and 104′ or the noncontact elements 105 and 105′ are selectively used to perform the data transfer between the card interface unit 101 and the card-shaped electronic apparatus 101′.

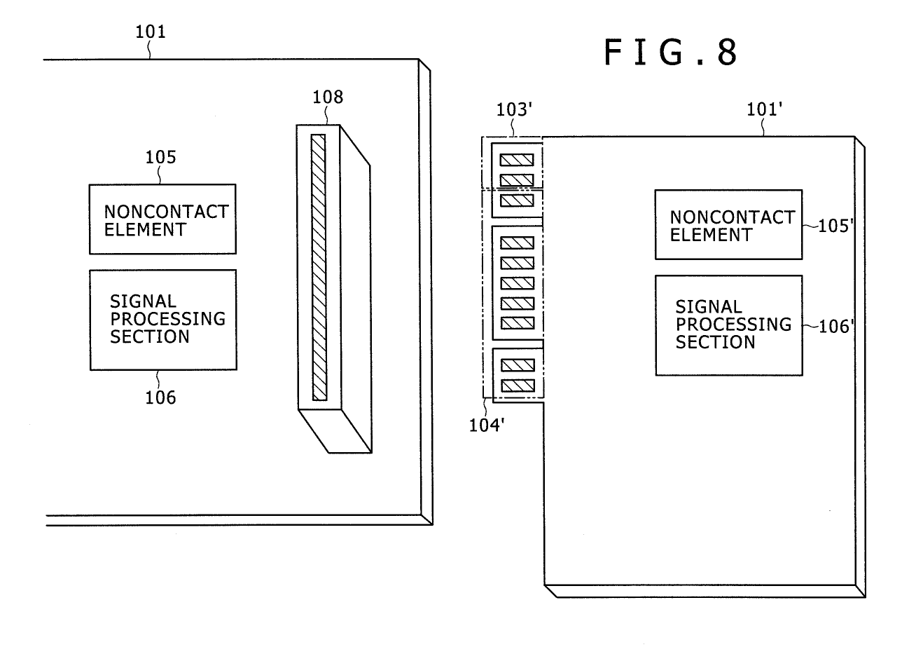

FIG. 8 illustrates a second specific example. In this example, the electronic apparatus 101 at the transmitting end is a parent substrate such as a motherboard in a computer, while the electronic apparatus 101′ at the receiving end is a child substrate connected to this parent substrate. The parent substrate 101 is provided with a connector housing 108 that contains a plurality of power pins and a plurality of data pins internally, while the child substrate 101′ is provided with a plurality of power pins 103′ and a plurality of data pins 104′ corresponding to the power pins and the data pins, respectively, in the parent substrate 101. Each of the parent substrate 101 and the child substrate 101′ is provided with the noncontact element 105 or 105′, the signal processing section 106 or 106′, and the power supply section (not shown). As in the above-described embodiment, the data pins 104 and 104′ or the noncontact elements 105 and 105′ are selectively used to perform the data transfer between the parent substrate 101 and the child substrate 101′.

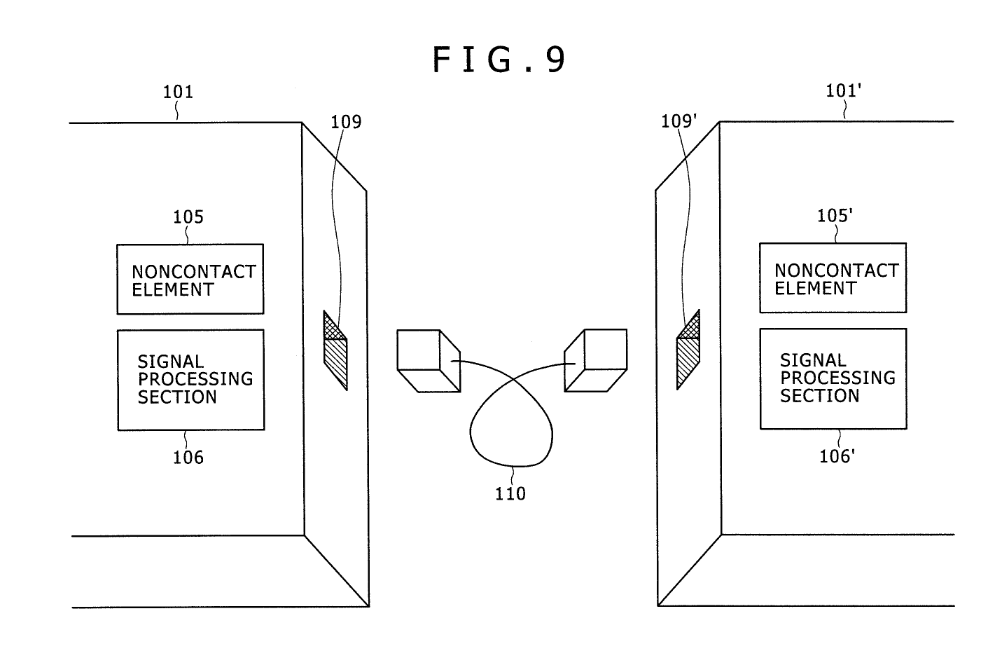

FIG. 9 illustrates a third specific example. In this example, the electronic apparatus 101 at the transmitting end and the electronic apparatus 101′ at the receiving end are separate devices that are connected to each other via a cable 110. Examples of the devices include computers and their peripherals (e.g., printers, scanners, media recorders/players, hard disk drives, communication devices, digital still cameras, digital video cameras, etc.). The devices 101 and 101′ are provided with connector housings 109 and 109′, respectively, each of which has a plurality of power pins and a plurality of data pins. The connector housings 109 and 109′ of the respective devices 101 and 101′ can be connected to each other via the cable 110, which has connectors. Each of the devices 101 and 101′ is provided with the noncontact element 105 or 105′, the signal processing section 106 or 106′, and the power supply section (not shown). As in the above-described embodiment, the data pins in the connector housings 109 and 109′ or the noncontact elements 105 and 105′ are selectively used to perform the data transfer between the devices 101 and 101′.

Note that it has been assumed in the above-described embodiment that either the transmission path of the data pins or the transmission path of the noncontact elements is used to perform the data transfer. Note, however, that both the transmission paths of the data pins and the noncontact elements may be used at the same time to perform the data transfer. For example, in the case where data that requires transfer at a still higher speed is to be transferred, it may be so arranged that the transmission capacity of the transmission path of the noncontact elements is fully used and that at the same time the transmission path of the data pins is also used in combination, in order to increase the transmission capacity.

Note that the present invention is not limited to the electronic apparatuses and information transfer methods that have been described above with reference to the accompanying drawings. It should be understood by those skilled in the art that various modifications, combinations, sub-combinations and alterations may occur depending on design requirements and other factors insofar as they are within the scope of the appended claims or the equivalents thereof.

What is claimed is:

1. An electronic apparatus, comprising:
an electrical contact configured to establish an electrical connection with another electronic apparatus to input or output information from or to the other electronic apparatus;
a noncontact element configured to input or output information from or to the other electronic apparatus in a noncontact manner; and
a signal processing section configured to exercise control over transfer of the information between the electronic apparatus and the other electronic apparatus, while selectively using said electrical contact and said noncontact element.

2. The electronic apparatus according to claim 1, wherein said signal processing section includes:
a switch block configured to switch a transmission path for information transfer between the electronic apparatus and the other electronic apparatus between said electrical contact and said noncontact element; and
a determination block configured to control the switch block in accordance with the information transferred between the electronic apparatus and the other electronic apparatus.

3. The electronic apparatus according to claim 2, wherein the determination block determines whether the information transferred involves a speed constraint, and if the determination block determines that the information involves a speed constraint, the determination block controls the switch block to select said noncontact element, whereas if the determination block determines that the information does not involve a speed constraint, the determination block controls the switch block to select said electrical contact.

4. The electronic apparatus according to claim 3, wherein,
said signal processing section further includes an encoding block configured to encode the information transferred in accordance with a first system or a second system, the first system being suitable for information transfer using said noncontact element, the second system being suitable for information transfer using said electrical contact, and
if the determination block determines that the information transferred involves a speed constraint, the encoding block encodes the information in accordance with the first system, whereas if the determination block determines that the information transferred does not involve a speed constraint, the encoding block encodes the information in accordance with the second system.

5. The electronic apparatus according to claim 4, wherein,
if the determination block determines that the information transferred does not involve a speed constraint, the determination block identifies an important portion of the information and outputs a result of the identification to the encoding block, and
the encoding block determines the second system used to encode the information, based on the result of the identification outputted from the determination block.

6. The electronic apparatus according to claim 5, wherein said signal processing section transfers, to the other electronic apparatus via said electrical contact, a notification including information specifying the transmission path and information concerning encoding.

7. The electronic apparatus according to claim 1, further comprising
a second electrical contact configured to establish an electrical connection with the other electronic apparatus to input or output power from or to the other electronic apparatus.

8. The electronic apparatus according to claim 1, wherein said signal processing section includes:
a switch block configured to switch a transmission path for information transfer between the electronic apparatus and the other electronic apparatus between said electrical contact and said noncontact element; and
a determination block configured to receive, from the other electronic apparatus via said electrical contact, a notification including information specifying the transmission path, and to control the switch block based on the information included in this notification.

9. The electronic apparatus according to claim 8, wherein said signal processing section further includes a decoding block configured to receive, from the other electronic apparatus via said electrical contact, a notification including information concerning encoding, and, based on the information included in this notification, decode the information transferred from the other electronic apparatus via the transmission path selected by the switch block.

10. An information transfer method for transferring information between a plurality of electronic apparatuses, each of the electronic apparatuses having an electrical contact configured to establish an electrical connection with another one of the electronic apparatuses to input or output information from or to the other electronic apparatus, and a noncontact element configured to input or output information from or to the other electronic apparatus in a noncontact manner, wherein
the information is transferred between the electronic apparatuses, with selective use of the electrical contacts and the noncontact elements.
